(19) United States
(12) Patent Application Publication
(10) Pub. No.: US 2023/0244962 A1
(43) Pub. Date: Aug. 3, 2023

(54) EVALUATING BLACK BOX MODELING OF TIME-SERIES DATA

(71) Applicant: THE TORONTO-DOMINION BANK, TORONTO (CA)

(72) Inventors: Maksims Volkovs, TORONTO (CA); Kin Kwan Leung, Toronto (CA); Saba Zuberi, Toronto (CA); Jonathan Anders James Smith, Toronto (CA); Clayton James Rooke, Toronto (CA)

(21) Appl. No.: 17/957,879

(22) Filed: Sep. 30, 2022

Related U.S. Application Data
(60) Provisional application No. 63/305,769, filed on Feb. 2, 2022.

(51) Int. Cl. G06N 5/04; G06N 20/00

(52) U.S. Cl. CPC G06N 5/04; G06N 20/00

(57) ABSTRACT

A model evaluation system evaluates the effect of a feature value at a particular time in a time-series data record on predictions made by a time-series model. The time-series model may make predictions with black-box parameters that can impede explainability of the relationship between predictions for a data record and the values of the data record. To determine the relative importance of a feature occurring at a time and evaluated at an evaluation time, the model predictions are determined on the unmasked data record at the evaluation time and on the data record with feature values masked within a window between the time and the evaluation time, permitting comparison of the evaluation with the features and without the features. In addition, the contribution at the initial time in the window may be determined by comparing the score with another score determined by masking the values except for the initial time.

### CROSS-REFERENCE TO RELATED APPLICATION

This application claims the benefit of provisional U.S. Application No. 63/305,769, filed Feb. 2, 2022, the contents of which are incorporated herein by reference in its entirety.

### BACKGROUND

This disclosure relates generally to evaluating the impact of one or more features in time-series model predictions, and more particularly to evaluating the effect of features at one time on model predictions across a time window.

Modem, complex computer models can include a large number of layers that interpret, represent, condense, and process input data to generate outputs. While the complexity of these models is often beneficial in improving a model’s outputs with respect to a desired learning objective, the complexity may be a severe drawback for human understanding of the relationship between model inputs (e.g., an individual data instance / data item) and the output. As the complexity of the models increases, the processing and functions within the model may become more and more difficult to interpret, particularly as the effective relationship between inputs and output predictions becomes more complex. Moreover, understanding the effects of different inputs on the model output may be further complicated by multidimensional features (which may also be called feature vectors) that may vary over time, such that understanding the character of a particular feature value at a particular point in time on the model’s predictions may make such analyses especially difficult for complex, black-box models.

Further, models that predict outputs for time-series data (e.g., data with features that may change over a sequence) may make a set of predictions for each timestep, and the effect of a particular feature at a particular time step on model predictions may differ across differing time spans, such that a feature may insignificantly affect the current prediction, may significantly affect predictions in several time steps, and may modestly affect predictions after that. For example, a model may learn to predict a potential medical diagnosis based on a history of observations or tests for a patient (e.g., features such as heart rate, blood pressure, blood constituents, etc.). The effect of these features (e.g., an elevated heart rate or blood pressure) on the likelihood of the medical diagnosis may not appear immediately in model predictions (e.g., within six months or a year), but may significantly affect learned future predictions (e.g., predictions at 3, 5, or 10 years). For complex time-based computer models, the respective contribution of individual features (or a subset thereof) on different time windows may be difficult to determine with any precision. In addition, for time-series data, observations of the same feature at different points in time are typically related and the order of particular observations also matters. As such, approaches that highlight important observations, but treat these observations as independent, face significant limitations. Furthermore, different observations of a given feature can have varying importance to model predictions over time. For example, there can be a delay between important feature shifts and a change in the model’s predictions. As such, time-series data introduces additional challenges for explaining model predictions for a data item, as the same feature can have varying importance to model predictions over time. These temporal dynamics of feature importance can be difficult for current methods to capture.

Without an understanding of these effects, complex models, particularly “black-box” models may be difficult to trust, understand, or validate, particularly with respect to predictions for individual data items. Reliably explaining predictions of machine learning models is increasingly important given their wide-spread use. Explanations are needed to provide transparency and aid reliable decision making, especially in healthcare, legal, and financial applications. Multivariate time-series data is ubiquitous in these sensitive domains, while the explanation of model predictions is relatively under-explored.

Moreover, approaches that provide an explanation for the model’s predictions, without requiring detailed analysis of the model itself, can be used to validate models for which the internal model details may not be available, enabling a model-agnostic analysis of the predictive relationships by the model for time-series data.

### SUMMARY

To improve evaluation of computer model predictions for time-series data, one or more importance scores are determined that describe how a computer model’s predictions for a particular time-series data record are affected by a subset of features occurring at a particular time in the data record. Though generally discussed herein as relating to data having features that vary over time (e.g., individual observations or features associated with a particular time), the approaches discussed herein apply to other data records in which features may vary across an ordered sequence of steps, such that a first value of a particular feature at one step may have a different value at a subsequent (or prior) step.

To determine the effect of features (i.e., a subset of the features as a whole) with respect to the predictions over time, the subset of features is masked for a time window and the different predictions from the model is evaluated with respect to the unmasked and masked data record. The difference in predictions (e.g., measured as a KL-divergence) for the masked and unmasked data indicates the effect of (i.e., the importance) of the subset of features within that time window with respect to the model predictions. In some embodiments, the features may be masked in the data using sampled data from a generative model conditioned on prior data in the data record, which may prevent the masked data from overly biasing the model predictions.

To further refine the importance score from describing features with respect to the time window as a whole to describing the effect of features at an initial timestep on the time window, another importance score is determined in which the features are masked in the time window, except for the initial timestep, such that the effect of the model predictions (on model predictions compared with the unmasked data) with and without masking at the initial timestep demonstrates the effect of the feature at the initial timestep as it affects predictions in the time window. This approach may also be used to determine aggregate effects of a feature (or subset of features) across different timeframes by determining the importance of the feature at different time windows. These various importance scores permit the effective evaluation of particular features as they occur at particular times in the time-series data on future predictions of the model.

### BRIEF DESCRIPTION OF THE DRAWINGS

FIG. 1 is an example environment for a model evaluation system, according to one embodiment.

FIG. 2 illustrates the application of a time-series model to a time-series data record, according to one embodiment.

FIG. 3 shows an example for determining a feature-window importance score, according to one embodiment.

FIG. 4 shows an example feature-step importance score, according to one embodiment.

FIG. 5 shows an example of calculating an aggregate feature importance score, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

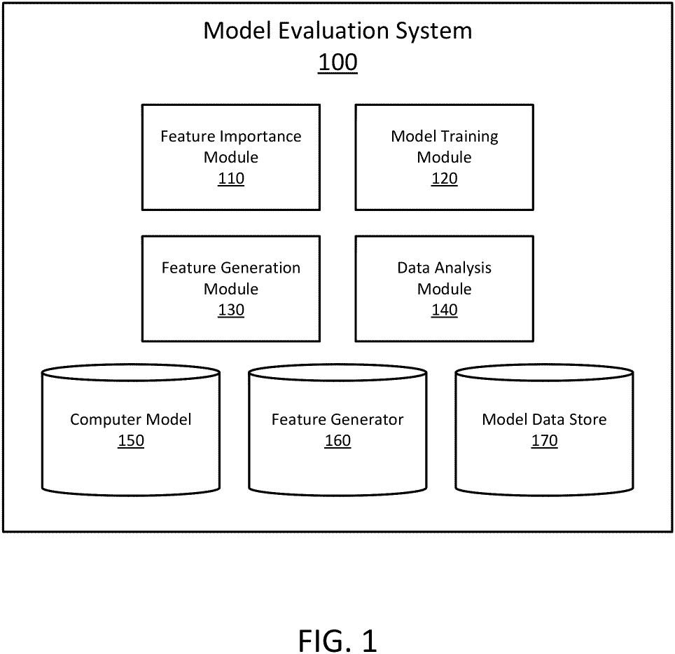

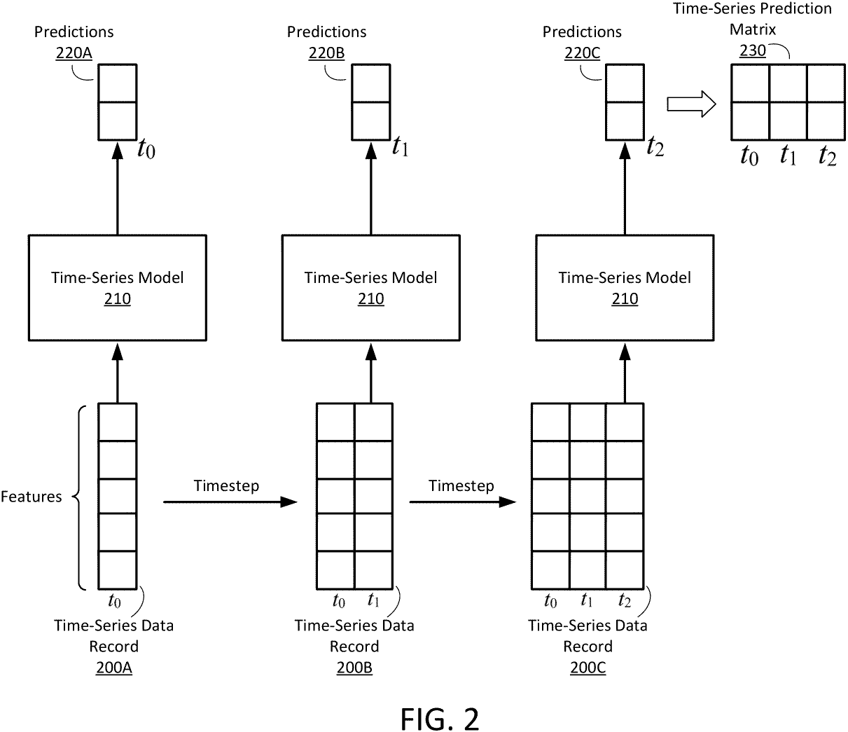

FIG. 1 is an example environment for a model evaluation system 100, according to one embodiment. The model evaluation system 100 evaluates the importance of a set of features in a data record to predictions of a computer model 150. The computer model 150 may be a trained computer model having parameters learned via a training process executed by a model training module 120 based on a set of training data, which may be stored in a model data store 170. The computer model 150 is configured to receive a time-series data record (e.g., a data instance of associated time-sequenced data having multiple features that may vary across the time) and generate one or more predictions for a particular timestep. The computer model 150 and its generation of predictions is further discussed with respect to FIG. 2.

The model evaluation system 100 includes a feature importance module 110 that determines one or more importance scores that describe the effects of one or more features (e.g., a subset of the features in a data record) in a time window of model predictions. The effect of a feature on predictions may also be referred to as an “importance score.” Several types of importance scores are discussed herein, and generally refer to the informational loss on model predictions as a result of the values of the subset of features at particular times.

In addition, the importance scores discussed herein may be determined with respect to an individual data record, such that importance scores may be generated to analyze the informational effects of individual feature values in model predictions of that specific data record. For example, in a medical application, the individual data record may describe information collected for an individual patient over time, where each feature may describe a measured value for the patient, such as the patient’s blood pressure, heart rate, blood test values, and so forth. The model may be configured to predict the likelihood of an adverse medical event, such as the mortality risk in a given year. The importance score may then be used to measure the effect of individual features at particular times on the model-predicted risk. Because the importance score may be evaluated for a particular data record, the importance score may be used to determine the importance of specific features, at specific times, for predictions made by the model for this individual patient (i.e., based on that patient’s data record).

The trained computer model 150 thus may be a computer model that provides an output based on a multi-dimensional (e.g., multi-feature) input that may vary over time. In generating predictions for a particular time, the model may use the data at that time along with the previous data in the data record. For example, to generate predictions at time t₅, the model may receive and process values for times t₀₋₅. A particular input for the computer model 150 is termed a “data record” or “data instance.” The data record may include a set of features across a number of a sequenced timesteps, such that each value in a vector represents the value of a different feature and each timestep may represent that feature at that particular time. While values for features may be typically described herein as integers for simplicity, in practice, the feature values may describe characteristics of the data instance with any suitable data type or structure in which the value may be represented with different values, such as a percentage, float, Boolean values, etc. The individual features of the feature vector may thus be represented in the feature vector with the corresponding data type, which may differ across the individual features.

The computer model 150 may include various layers to process an input to generate an output according to the structure of the layers and the trained parameters of the trained computer model 150. The computer model 150 may also include recurrent, looping, accumulative, or other types of layers or intermediate data representations that accrue information about the sequence of timesteps as inputs to the computer model. The various layers may also include layers that reduce the dimensionality of the data, determine intermediate representations, and various further processing and functions (e.g., activation functions) for generating an output. In general, these various layers may be difficult for a human user to understand directly, as the trained parameters may not readily be understood with respect to how any particular feature changes the outputs of the model and how different regions of the input space are modeled. The model training module 120 may train the parameters of the computer model 150 based on the data records in the training data set.

As discussed further below, the feature importance module 110 may mask a portion of a data record to determine importance scores in model predictions. In some embodiments, the model evaluation system 100 may include a feature generation module 130 and a corresponding feature generator 160. The feature generator 160 is a computer model or other predictor that generates a feature value for one or more features in a data record. In some embodiments, the feature generator 160 may generate a probability distribution of the masked features based on the previous timesteps of the data record. That is, the feature generator 160 may generate a feature value for one or more features (e.g., a subset of features) for a particular timestep conditioned on previous feature values of the data record. More formally, the feature generator 160 learns to predict masked features in a window of length n starting at a timestep t for masked feature subset S in data record X: p(X_{S,t:t+n}|X_{1:t-t}). Functionally, this is given by:

$$p \left({X}_{S , t : t + n} \left|{\text{X}}_{1 : t - 1}\right)\right) = {G}_{S} \left({\text{X}}_{1 : t - 1} , n + 1\right)$$

In which G_{S} is the feature generator, X_{1:t-1} is the data record from the initial time step t₁ to the timestep t at which the time window begins, and a position n+1 for which to generate values using the length of the time window (n) for analysis, as further discussed below.

The feature generator 160 may be any suitable model that may generate a probability density or from which values for desired features may be sampled. The feature generator 160 may be trained by the model training module 120 based on the training data in the model data store 170. Values from the feature generator 160 may then be sampled for use as the value for the masked features in the importance score analysis.

The data analysis module 140 provides for additional analyses and actions based on the importance scores generated by the feature importance module 110. In various embodiments, the data analysis module 140 may provide for analyses to users, visualization of importance scores, the analysis and verification of a model, and other supplemental services based on the importance score.

As such, in one embodiment the data analysis module 140 uses the importance scores to provide insight to a user of a client device to more intuitively understand the relationships between inputs and outputs of the computer model 150 to gain insight into the model whose complexities and parameters may otherwise render it a “black box” without clear explanation of the translation from input to output. The data analysis module 140 may thus generate various interfaces for display to the user for analyzing, exploring, and understanding the performance of the model. The client device operated by a user may be any suitable device with a display for presenting the interfaces to a user and to receive user input to navigate the interfaces. As examples, the client device may be a desktop computer, laptop computer, or server terminal, as well as mobile devices, touchscreen displays, or other types of devices which can display information and provide input to the model evaluation system 100. In one embodiment, the user may select a data record for the computer model 150 to perform predictions, and the data analysis module 140 may provide the data record to the feature importance module 110 for generating one or more importance scores for the features of the data record as they impact model predictions. The importance scores may thus be evaluated for an individual data record, and as discussed further below may reflect the effect of individual features as occurring at individual times and reflecting the effect of the features at different (or aggregated) time windows. The importance scores of particular features at particular times may be color-coded or otherwise visually indicated to permit the user to view and navigate the relative importance of features in the record. The visualization of this information may enable a user to effectively navigate and understand the effects of the importance scores on the predictions generated by the model.

In addition to visualizing the importance scores, the user may also use the importance scores of features in conjunction with the predictions from the model to understand and verify the predicted results from the model. Continuing the medical example, the model may predict an increased mortality risk for a patient. The importance scores may be used to identify that an elevated blood pressure reading from several years ago significantly contributed to the increased mortality risk output by the model. The user may compare this outcome (e.g., the prediction from the model of increased mortality risk) with specialized medical knowledge or known causes of increased mortality risk to validate that the importance of the elevated blood pressure reading is a medically-supported cause for the prediction of increased mortality risk by the model. As such, in various circumstances, the user may use the importance scores and the visualization thereof to view the importance of various information, as it occurs in time, to verify the results of the model as applied to individual data records (in this example, for individual patients). Similarly, model results that yield unexpected predictions for a particular data record may be investigated to determine the features (and timing of those features) that yielded the model predictions, which may then be used to determine whether to reconsider the model’s prediction in a particular case, or suggest additional analysis or study may confirm the relationship identified by the feature importance to the model.

In addition, the data analysis module 140 may also be configured to automatically validate or retrain a model based on the importance scores determined by the model for particular predictions. While models may typically be validated against a validation set of data after training, the importance scores may also be used to validate the features learned as important against designated features (which may be associated with particular timesteps) expected to be important in the data. In some circumstances, the features may be associated with designated or “expected” feature importance. For example, the relative importance of a feature may be associated in some circumstances with human-designated or experimental (e.g., controlled scientific experiments) values. The importance scores for features at particular times for a data record (or for multiple data records) may be compared with these “expected” feature importance values. When the importance scores are consistent with the expected importance, a trained model may be considered validated and used in additional circumstances. When the importance scores are inconsistent with the expected importance, the trained model may be retrained, and in some circumstances, the importance scores may be highlighted to a user to evaluate whether to use the trained model, to revise the expected importance, or may be used as a signal to a user for further investigation.

As another application, the importance scores and the different-sized windows in analyzing the importance of the scores may also be used to suggest increased or reduced frequency of data collection. For example, varying the window in which features are examined for importance scoring may indicate that similar informational content may be obtained by the same feature at sequential sampling times, such that the sampling frequency may be reduced and still gain the informational benefit of the feature value in model evaluation.

### Time-Series Prediction

FIG. 2 illustrates the application of a time-series model 210 to a time-series data record 200, according to one embodiment. The data record includes a set of features that may vary across time, such that each timestep may have an associated set of features in the data record (e.g., a number of sequential or ordered observations). The time-series data record is shown here as additional features are added with each timestep, indicated here as time-series data record 200A-C. Generally, predictions may be generated by the model according to the input time-series data record and correspond to “last” time step of the time-series data record, such that the time-series data record 220A for time t₀ yields an associated prediction 220A at time t₀. The predictions at a particular timestep may vary according to the particular application of the time-series model 210, and may include, for example, a predictive or classification task, and in some examples may include two mutually-exclusive classes (e.g., one class corresponding to “yes” and another corresponding to “no”).

The time-series model 210 may thus be applied to generate a set of predictions 220A-C for each time step based on the features of that particular timestep and prior timesteps in the data record. As such, the prediction 220A for time-series data record 200A accounts for features in timestep t₀. Subsequent predictions 220B and 220C from the time-series model 210 may incorporate additional features from t₁ and t₂ of time-series data records 200B and 200C respectively. As such, predictions 220 for later time steps (e.g., times t₁ and t₂), may be affected by feature values of earlier timesteps in the time-series data record. The effect of a feature value occurring at time t₀, for example, may significantly affect prediction 220C at time t₂.

The accumulated set of predictions 220 generated by the model across respective timesteps for a data record may be referred to as a time-series prediction matrix 230. As such, the predictions of the time-series model 210 for a particular timestep (e.g., in the time-series prediction matrix 230) may account for the features in a time-series data record that occur at or before the respective timestep.

The following notation may also be used to describe the time-series data record and associated predictions. The time-series data record may also be referred to as X, having values across feature dimensions D and across a sequence of times T: X ∈ ℝ^{D×T}. The feature values in the time-series data record 200A from the first record at time t₁ to a time t may be designated as X_{1:t} and thus be described as X_{1:t} := [x₁; x₂; ...; xₜ] ∈ ℝ^{D×t}.

In addition, the model predictions at a particular time t may be designated yₜ for a number of predictions (e.g., classifications) designated 1 ... K. More formally, the model may generate predictions (which may be a conditional distribution) at each timestep t as a function of the preceding timesteps in the data record: p(yₜ|X_{1:t}), as also shown in FIG. 2.

### Feature-Window Importance Score

To evaluate the effect of a particular subset of features S at a particular timestep on the model predictions, one or more importance scores may be determined as a function of a subset of features that occur at a particular timestep. A feature-window importance score may be determined that describes the effect of the feature subset S across a window of timesteps (e.g., a window of 3 timesteps).

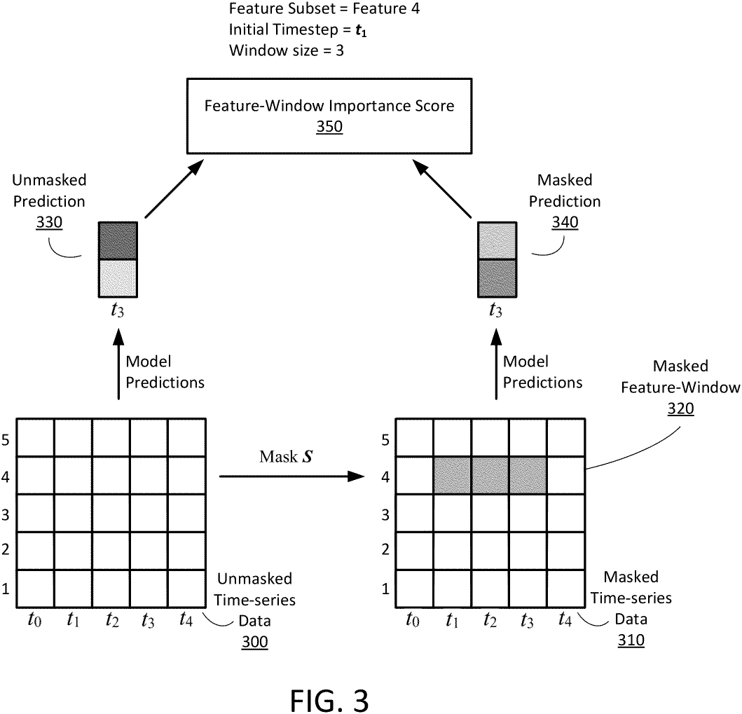

FIG. 3 shows an example for determining a feature-window importance score 350, according to one embodiment. The feature-window importance score 350 may be generated for a particular subset of features S, occurring at a particular time t, as it affects a prediction time t + n. In the example of FIG. 3, the time t is t₁ and the prediction time t + n is t_{3.} To determine the feature-window importance score 350, an unmasked prediction 330 is generated by the model for the data record and a masked prediction 340 is generated based on data record having the subset of features S masked within the window of timesteps. The original time-series data record is shown as the unmasked time-series data 300, in which the data record may be used for predictions as it may normally be used (e.g., without alteration). Using the time-series model, e.g., as shown in FIG. 2, the associated model predictions based on the unmasked time-series data 300 may be generated for the prediction time to generate the associated unmasked prediction 330. As discussed with respect to FIG. 2, the prediction at a given timestep may be based the respective timestep in the unmasked time-series data 300 along with prior timesteps (e.g., the prediction for t₃ may be based on timesteps t₀₋₃ in the unmasked time-series data). The predictions for the individual timesteps may be combined to yield the time-series prediction matrix as shown in FIG. 2.

To determine the effect of a subset of features S (which may also be termed a feature subset) on the model predictions for a time window n, the subset of features is masked to generate a masked time-series data record 310. In the example of FIG. 3, the feature subset S is feature 4 and is masked in the time window t₁-t₃, indicated in FIG. 3 as a masked feature-window 320. The feature may be masked for a window n to the designated evaluation time t + n . In this example, the window n is 2, such that the value of the subset is masked from t to t + n ; in this example from t₁ to t_{3.}

As discussed further below with respect to the aggregated importance score, multiple time windows may be evaluated, up to a maximum time window N. The maximum time window N is typically two or more timesteps, such that the evaluation of predictions for time windows up to the maximum may demonstrate the effect of the feature subset over several timesteps. Individual time windows to be evaluated may be designated n, such that the time window includes a number of timesteps that may be evaluated from the initial time t being evaluated (e.g., t₁) to designate a number of steps beyond the initial timestep, where n is typically designated from 0 to N — 1. For example, where the maximum time window N is 3, the values of time window n may be evaluated at 0, 1, and 2.

The time-series model is applied to the masked time-series data record 310 at the evaluated timestep (i.e., t + n) to generate an associated masked prediction 340 similar to the generation of the unmasked prediction 330. In this case, the observation time of interest begins at t₁, such that the model predictions are made for n = 2, corresponding to t₃ for the unmasked prediction 330 and the masked prediction 340.

The values used to mask the features may be set to zero, copy the values of previous timesteps in the data record, or may be determined based on a generative model (e.g., the feature generator 160 discussed above). The mask may be applied to mask the values of the data record, such that a comparison of the unmasked prediction 330 and the masked prediction 340 may indicate the importance of the subset of features S within the window with respect to the predictions at the evaluated time, which is typically in the future from the from the initial time of the window). The feature-window importance score 350 is a value describing the result of the comparison. In some embodiments, the comparison may be evaluated by the KL-divergence between the unmasked prediction 330 and the masked prediction 340.

This feature-window importance score 350 may thus indicate the “information loss” to the timeseries model of the unmasked vs. masked values of the features in the modified predictions of the masked prediction 340 on predictions at the evaluated time t + n. When the masked feature values are based on a generative model, values may be sampled from a distribution of the generated model to determine the masked time-series data 300 and calculate the masked prediction 340 as an average over the distribution of values.

Formally, the feature-window importance score 350 may be defined as

$$i {\left(S\right)}_{t}^{t + n}$$

to describe the feature-window importance score i of feature subset S at time t across window n and evaluated at time t + n, and in one embodiment is:

$$i {\left(S\right)}_{t}^{t + n} = K L \left(p \left({y}_{t + n} \left|{\text{X}}_{1 : t + n}\right)\right) \left‖p \left({y}_{t + n} \left|{\text{X}}_{1 : t - 1} , {\text{X}}_{{S}^{c} , t : t + n}\right)\right)\right)\right)$$

in which:
KL calculates the KL divergence;
p(yₜ₊ₙ|X_{1:t+n}) is the unmasked prediction 330 at time t + n for the unmasked time-series data 300 X₁_{:t+n}; and

$$p \left({y}_{t + n} \left|{\text{X}}_{1 : t - 1} , {\text{X}}_{{S}^{c} , t : t + n}\right)\right)$$
is the masked prediction 340 at time t + n for the masked time-series data 310, in which the masked values are used for the time t: t + n.

### Feature-Step Importance Score

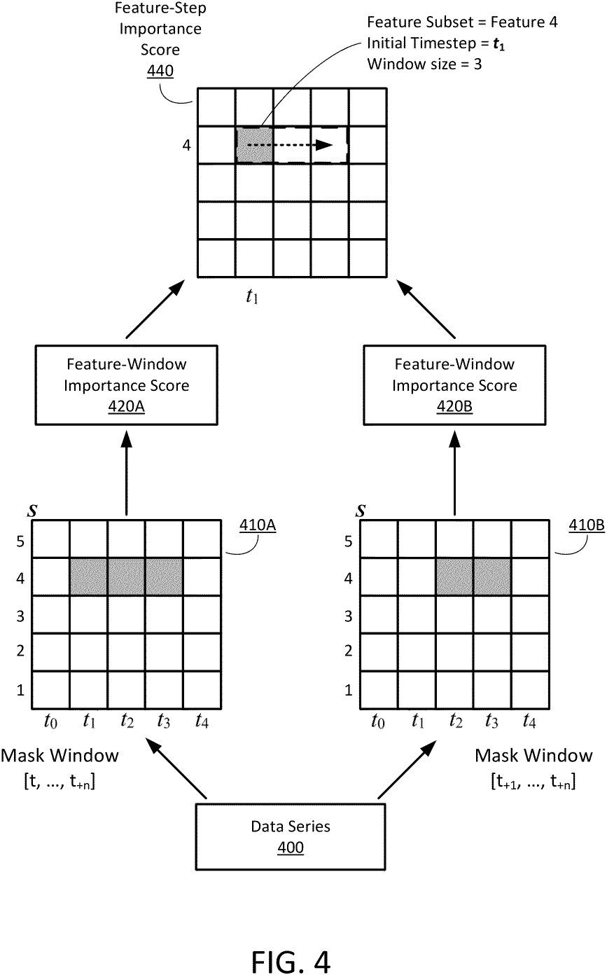

FIG. 4 shows an example feature-step importance score 440, according to one embodiment. A feature-step importance score, may be determined to indicate the contribution of the subset of features S at an initial timestep of the window (e.g., at t) on the predictions evaluated at the end of the window (e.g., t + n). That is, where the feature-window importance score may indicate the effect of masking the feature subset in the entire window, the feature-window importance score alone may not indicate the respective importance of the feature subset at the initial timestep (t) on the changed model predictions at the evaluated timestep (t + n). To determine the feature-step importance score 440, the data series 400 may be processed with the window of length n to generate a masked time-series data record 410A and yield a feature-window importance score 420A as discussed with respect to FIG. 3. To isolate the effects of the initial timestep on the modified predictions, an additional feature-window importance score 420B may be determined for the window in which the subset of features is masked for the window except for at the initial timestep, such that the masked time-series data record 410B does not mask the initial timestep, having a window that begins at time t₊₁ rather than at the initial time t. In the example of FIG. 3, where the window is of length 3, the masked time-series data record 410A has the mask applied to time t₁ through time t₃, where the initial timestep is omitted from the mask in the masked time-series data record 410B, such that the mask is applied to times t₂ and t_{3.}

The corresponding feature-window importance scores 420A-B are likewise generated as discussed with respect to FIG. 3. Using the notation of Equation 1 above, the feature-window importance score 420A may be represented as

$$i {\left(S\right)}_{t}^{t + n}$$

while the feature-window importance score 420B may be represented as:

$$i {\left(S\right)}_{t + 1}^{t + n} ,$$

indicating that the masked values begin at t + 1 rather than t. The feature-step importance score 440 may then be represented as I(S,t,n) as a function I of the feature subset S, time t, and evaluated for predictions at time t + n based on feature-window importance scores 420A-B. In one embodiment, the feature-step importance score 440 is determined based on a comparison (e.g., a difference between) of the feature-window importance score 420A and feature-window importance score 420B. This may be defined in one embodiment as:

$$\begin{matrix}I \left(S , t , n\right) = i {\left(S\right)}_{t}^{t + n} - i {\left(S\right)}_{t + 1}^{t + n} ; 0 < \text{n} \\ \text{For} n = 0 , I \left(S , t , 0\right) = i {\left(S\right)}_{t}^{t}\end{matrix}$$

That is, the difference in feature-window importance scores 420A-B captures the difference in information loss between masking the subset for the entire window and isolating the initial timestep. Stated another way, the feature-step importance score 440 thus reveals the difference between masking the subset in the entire length of the timestep for a window and masking the subset in the remaining length of the window (without the initial timestep). As shown in Equation 2, when the window is a single timestep (e.g., n = 0), the feature-step importance score may equal the feature-window importance score (e.g., of a single timestep window).

By comparing the feature-window importance score 420A reflecting the features masked for the entire window with the additional feature-window importance score 420B in which the features are masked for a shorter window (i.e., excluding the initial timestep ti), the effects of the subset of features on the window at the initial timestep can be distinguished from similar effects of the same feature subset at later timesteps in the window. This approach may thus isolate the respective contribution of the feature subset at the beginning of the window and disambiguate the effects of the feature subset across the window, which may be correlated with both future values of the feature and the respective informational content of those values on model predictions. Stated another way, the feature-step importance score 440 may thus attribute importance scores to timesteps in which new information that impacts predictions is first introduced, as later redundant observations will cancel in evaluations of I(S,t,n).

### Aggregate Feature Importance Score

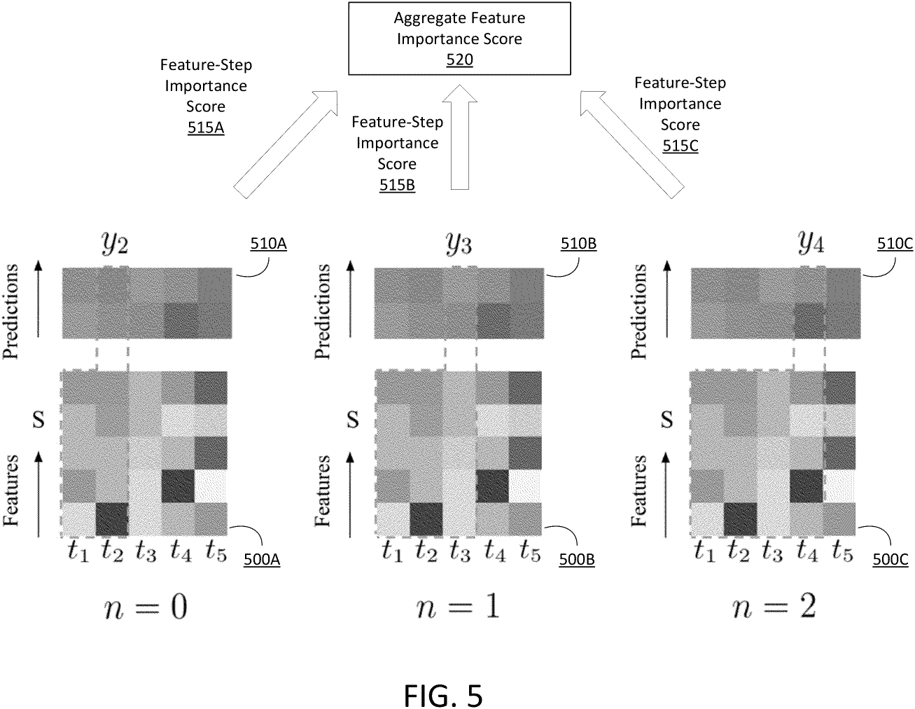

FIG. 5 shows an example of calculating an aggregate feature importance score 520, according to one embodiment. The feature-step importance score, for example, may be used to determine the importance of a feature subset S occurring at a time t and evaluated at t + n (e.g., at window length n). To determine the effect of a feature S at time t as it affects several future points in time, an aggregate importance score I(S,t) may be evaluated as a function of the feature subset S and the time t that the feature value occurs in the data record. The feature-step importance scores may be generated for a variety of timeframes (e.g., across different window lengths) to determine an aggregate feature importance score 520 for the feature subset. In some embodiments, the feature-step importance scores may be determined for a number of windows up to the maximum time window N.

Typically, the importance scores may be aggregated across a plurality of windows. The example of FIG. 5 shows the feature subset S evaluated for a maximum time window N of 3 starting at time t = t₂. To do so, the feature-step importance scores 515A-C may be generated based on respective time windows of 0, 1, and 2 from time t₂. FIG. 5 illustrates the portions of a data record 500A-C used to generate the respective predictions 510A-C for the respective feature-step importance scores 515A-C. For window size n = 1, the respective portion of the data record 500A used in generating predictions 510A and respective feature-step importance score 515A may include the features at times t₁ and t₂. Similarly, the portion of the data record 500B used for predictions 510B may include features at times t₁, t₂, and t_{3.} Finally, the portion of the data record 500C for window size 3 for predictions 510C includes features at times t₁ - t₄.

In some embodiments, the aggregate feature importance score 520 is determined as the sum of the feature-step importance scores across the different window sizes (e.g., of feature-step importance scores 515A-C). In other embodiments, the aggregate feature importance score 520 may instead be a mean, average, or other statistical measure based on the individual feature-step importance scores. The aggregate feature importance score 520 may thus provide a means for evaluating the informational value of the feature subset S at time t on future model predictions across varying time delays.

As the maximum window size N increases, this approach captures longer interactions between important signals and changes in prediction, which can lead to better performance since some signals can be heavily delayed. Note that N = 3 corresponds to looking backward two timesteps (plus the current one). In practice, the expected time delay may be used to set the maximum window size, or it may be empirically set based on the relative value of feature-step importance scores or sequential time steps as window sizes increase, which may indicate decaying effects of the features across time.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for determining the importance of a feature to model predictions, comprising:
a processor that executes instructions; and
a non-transitory computer-readable medium having instructions executable by the processor for:
identifying a time-series data record describing a plurality of features for each timestep of a sequence of timesteps;
generating an unmasked prediction describing a plurality of predictions for a timestep of the sequence of timesteps by applying a trained time-series model to the time-series data record, wherein the trained time-series model generates the plurality of predictions for the timestep based on previous timesteps in the sequence of timesteps;
generating a masked prediction by applying the time-series model to a masked time-series data record in which a feature subset of the plurality of features is masked for a window of timesteps in the sequence of timesteps; and
determining a feature-window importance score describing the effect on model predictions in the window of the feature subset based on a difference in the unmasked prediction and the masked prediction.

2. The system of claim 1, wherein the instructions are further executable for:
determining a second feature-window importance score based on a second masked prediction in which the feature subset is masked by the window except for an initial timestep of the window; and
determining a feature-step importance score describing the effect on model predictions in the window of the feature subset at the initial timestep based on a comparison of the feature-window importance score and the second feature-window importance score.

3. The system of claim 2, wherein the instructions are further executable for:
determining one or more additional feature-step importance scores for the feature subset for timestep at windows of different lengths beginning at the initial time step; and
determining an aggregate feature importance score based on the feature-step importance score and the one or more additional feature-step importance scores, the aggregate feature importance score describing the importance of the feature subset at the timestep on model predictions at a plurality of time windows.

4. The system of claim 1, wherein the feature subset is masked with values sampled from a feature generator.

5. The system of claim 1, wherein the instructions are further executable for validating the model based on the feature-window importance score.

6. The system of claim 1, wherein the instructions are further executable for retraining the time-series model based on the feature-window importance score.

7. The system of claim 1, wherein the instructions are further executable for determining a frequency to sample the feature subset based on the feature-window importance score.

8. A computer-implemented method comprising:
identifying a time-series data record describing a plurality of features for each timestep of a sequence of timesteps;
generating an unmasked prediction describing a plurality of predictions for a timestep of the sequence of timesteps by applying a trained time-series model to the time-series data record, wherein the trained time-series model generates the plurality of predictions for the timestep based on previous timesteps in the sequence of timesteps;
generating a masked prediction by applying the time-series model to a masked time-series data record in which a feature subset of the plurality of features is masked for a window of timesteps in the sequence of timesteps; and
determining a feature-window importance score describing the effect on model predictions in the window of the feature subset based on a difference in the unmasked prediction and the masked prediction.

9. The method of claim 8, further comprising:
determining a second feature-window importance score based on a second masked prediction in which the feature subset is masked by the window except for an initial timestep of the window; and
determining a feature-step importance score describing the effect on model predictions in the window of the feature subset at the initial timestep based on a comparison of the feature-window importance score and the second feature-window importance score.

10. The method of claim 9, further comprising:
determining one or more additional feature-step importance scores for the feature subset for timestep at windows of different lengths beginning at the initial time step; and
determining an aggregate feature importance score based on the feature-step importance score and the one or more additional feature-step importance scores, the aggregate feature importance score describing the importance of the feature subset at the timestep on model predictions at a plurality of time windows.

11. The method of claim 8, wherein the feature subset is masked with values sampled from a feature generator.

12. The method of claim 8, further comprising validating the model based on the feature-window importance score.

13. The method of claim 8, further comprising retraining the time-series model based on the feature-window importance score.

14. The method of claim 8, further comprising determining a frequency to sample the feature subset based on the feature-window importance score.

15. A non-transitory computer-readable medium for determining the importance of a feature to model predictions, the non-transitory computer-readable medium comprising instructions executable by a processor for:
identifying a time-series data record describing a plurality of features for each timestep of a sequence of timesteps;
generating an unmasked prediction describing a plurality of predictions for a timestep of the sequence of timesteps by applying a trained time-series model to the time-series data record, wherein the trained time-series model generates the plurality of predictions for the timestep based on previous timesteps in the sequence of timesteps;
generating a masked prediction by applying the time-series model to a masked time-series data record in which a feature subset of the plurality of features is masked for a window of timesteps in the sequence of timesteps; and
determining a feature-window importance score describing the effect on model predictions in the window of the feature subset based on a difference in the unmasked prediction and the masked prediction.

16. The non-transitory computer-readable medium of claim 15, wherein the instructions are further executable for:
determining a second feature-window importance score based on a second masked prediction in which the feature subset is masked by the window except for an initial timestep of the window; and
determining a feature-step importance score describing the effect on model predictions in the window of the feature subset at the initial timestep based on a comparison of the feature-window importance score and the second feature-window importance score.

17. The non-transitory computer readable-medium of claim 16, wherein the instructions are further executable for:
determining one or more additional feature-step importance scores for the feature subset for timestep at windows of different lengths beginning at the initial time step; and
determining an aggregate feature importance score based on the feature-step importance score and the one or more additional feature-step importance scores, the aggregate feature importance score describing the importance of the feature subset at the timestep on model predictions at a plurality of time windows.

18. The non-transitory computer-readable medium of claim 15, wherein the feature subset is masked with values sampled from a feature generator.

19. The non-transitory computer-readable medium of claim 15, wherein the instructions are further executable for validating the model based on the feature-window importance score.

20. The non-transitory computer-readable medium of claim 15, wherein the instructions are further executable for retraining the time-series model based on the feature-window importance score.
